(19) United States
(12) Patent Application Publication
(10) Pub. No.: US 2019/0258895 A1
(43) Pub. Date: Aug. 22, 2019

(54) OBJECT DETECTION FROM IMAGE CONTENT

(71) Applicant: Microsoft Technology Licensing, LLC, Redmond, WA (US)

(72) Inventors: Arun Sacheti, Redmond, WA (US); Xi Chen, Redmond, WA (US); Houdong Hu, Redmond, WA (US); Li Huang, Redmond, WA (US); Jiapei Huang, Redmond, WA (US); Meenaz Merchant, Redmond, WA (US)

(21) Appl. No.: 15/900,606

(22) Filed: Feb. 20, 2018

(51) Int. Cl. G06K 9/62; G06F 17/30

(52) U.S. Cl. CPC G06K 9/6215; G06K 9/6202; G06F 17/30277; G06F 17/3028; G06K 9/627

(57) ABSTRACT

Non-limiting examples of the present disclosure relate to object detection processing of image content that categorically classifies specific objects within image content. Exemplary object detection processing may be utilized to enhance visual search processing including content retrieval and curation, among other technical advantages. An exemplary object detection model is implemented to categorically classify an object. In doing, so an exemplary object detection model may classify objects based on: analysis of specific objects within image content, positioning of the objects within the image content and intent associated with the image content, among other examples. The object detection model generates exemplary categorical classification(s) for specific data objects, which may be propagated to enhance processing efficiency and accuracy during visual search processing. Exemplary categorical classifications may comprise hierarchical classifications of a detected object that can be used to retrieve, curate and surface content that is most contextually relevant to a detected object.

### BACKGROUND

Visual search processing attempts to match image content with visually similar images or related content. However, visual search indices typically struggle to accurately identify specific data objects within image content as well as relevance of such data objects to a context of the image content. This is because typical visual search indices focus on image labels (e.g., classification of a whole image) rather than identify categories and locations of specific objects within image content. Commonly, image classification processing attempts to categorize the entirety of the image content and fails to categorically classify and precisely locate specific objects within the image content. Image categories that are associated with image classification may be extracted from a different taxonomy from that which relates to modeling for object detection. Information mismatch between object detection and image classification modeling may have a negative impact for training and application of a ranker that attempts to merge such classifications. This may make visual search models less efficient from a processing standpoint as well as less accurate in identifying relevant results. An illustrative example of technical shortcomings of prior forms of image classification processing is evident when a user attempts an image search (of image content) and receives back no results or contextually un-related results.

### SUMMARY

In view of the foregoing technical shortcomings, non-limiting examples of the present disclosure relate to object detection processing of image content that categorically classifies specific objects within image content. Exemplary object detection processing may be utilized to enhance visual search processing including content retrieval and curation, among other technical advantages. An exemplary object detection model is implemented to categorically classify an object. In doing, so an exemplary object detection model may classify objects based on: analysis of specific objects within image content, positioning of the objects within the image content and intent associated with the image content, among other examples. The object detection model generates exemplary categorical classification(s) for specific data objects, which may be propagated to enhance processing efficiency and accuracy during visual search processing. Exemplary categorical classifications may comprise hierarchical classifications of a detected object that can be used to retrieve, curate and surface content that is most contextually relevant to a detected object.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIGS. 1A-1C illustrate exemplary processing examples related to object detection and generation of categorical classification for a detected object, with which aspects of the present disclosure may be practiced.

FIG. 2 illustrates an exemplary method related to object detection processing for the enhancement of visual search processing with which aspects of the present disclosure may be practiced.

FIG. 3 is a block diagram illustrating an example of a computing device with which aspects of the present disclosure may be practiced.

FIGS. 4A and 4B are simplified block diagrams of a mobile computing device with which aspects of the present disclosure may be practiced.

FIG. 5 is a simplified block diagram of a distributed computing system in which aspects of the present disclosure may be practiced.

### DETAILED DESCRIPTION

Non-limiting examples of the present disclosure relate to object detection processing of image content that categorically classifies specific objects within image content. Exemplary object detection processing may be utilized to enhance visual search processing including content retrieval and curation, among other technical advantages. An exemplary object detection model is implemented to categorically classify an object. In doing so, an exemplary object detection model may classify objects based on: analysis of specific objects within image content, positioning of the objects within the image content and intent associated with the image content, among other examples. The object detection model generates exemplary categorical classification(s) for specific data objects, which may be propagated to enhance processing efficiency and accuracy during visual search processing. Exemplary categorical classifications may comprise hierarchical classifications of a detected object that can be used to retrieve, curate and surface content that is most contextually relevant to a detected object. Furthermore, visual search processing may utilize the exemplary categorical classifications of specific data objects (and other propagated data including feature map data) during ranking processing. This further enhances accuracy and relevance of in surfacing contextually relevant results data (e.g., visual search results). As such, exemplary processing operations described herein enhance user experience and productivity of applications/services through back-end processing related to object detection and classification.

A non-limiting example of the present disclosure is now described. An object detection model is executed for detection of an object (or objects) within image content. An exemplary object detection model is further configured to generate one or more categorical classifications for the object within the image content. Data associated with categorical classification of the object (as well as other relevant signal data) may be propagated to enhance subsequent visual search processing. Visually similar images may be identified and filtered based on propagated data including the one or more categorical classifications. In doing so, exemplary categorical classifications may be compared (e.g., matched) with categorical data associated with visual search indices (e.g., categories of visual search indices, detected categories in index images), metadata in visual search indices and/or categorical classifications, keywords, etc., as well as other web indices, knowledge graphs, and entity relationship models, among other examples. Visually similar image content may be identified based on such a comparison. Filtering of visually similar images for the objects(s) of image content may comprise ranking results data for contextually relevance to a detected object. An exemplary ranker for visual search processing may be trained based on exemplary categorical object classifications provided by an exemplary object detection model. The ranker may analyze and rank retrieved content for contextual relevance to a detected object. An exemplary representation of a detected object may be surfaced through a user interface of a service (e.g., a search service). In at least one example, the representation of the detected object may comprise identification of the detected object, visual reference to a categorical classification for the detected object and/or filtered visually similar images for the detected object. In further examples, selection (through the user interface) of a detected object or data associated with an exemplary identification of the detected object may result in presentation of a bounding box that emphasizes the detected object.

Compared with existing solutions for visual search ranker training, features extracted by an exemplary object detection model (or models) contain more accurate shape and location information of the object, as well as rich contextual information. An exemplary object detection model may be configured to execute object detection processing and classification. The object detection model is configured to propagate detected information including layers of output and feature maps for the enhancement of visual search processing, where visual search processing may be executed at an object classification level. Propagated data from an exemplary object detection model may further be used for multi-modal ranking training of a ranker that is utilized during visual search processing. In one example, the object detection model may be applied to both a query image as well as indexed images to extract both object categories and feature vectors that represents the object in the detected bounding box. Feature vectors from query-side image content as well as indexed image content may be fed into ranker learning to tailor a visual search ranker for object classification evaluation. This may enable visual search processing to identify and output content that is more contextually relevant to a detected object as well as provide richer representations of image content (as compared with general image classification processing), among other technical advantages.

Accordingly, the present disclosure provides a plurality of technical advantages, among other benefits, that include but are not limited to: generation, training and implementation of an exemplary object detection model for enhanced object detection, localization and classification; improved processing operations that enhance visual search accuracy, relevance and quality through categorical object classification; enhancement of visual search ranking processing including adaption of a visual search ranker for object classification processing; addition of contextually relevant data/relationships to subsequently image indices, web indices, etc., for subsequent image content processing; improved processing efficiency of applications/services and associated computing devices through stream-lining of downstream processing of queries as image content through propagation of categorical object classification and other semantic data; improved processing efficiency of computing devices associated with an exemplary contextual image analysis application/service and/or content retrieval service (e.g., providing more relevant content retrieval, reduction in processing cycles and latency through minimization of the amount of queries being received, better management of storage/memory of computing devices) for computing devices that are utilized for processing operations described herein; improving cross-application usage and productivity of retrieval-based services (e.g., search engine services); and improved user interaction and productivity with front-end user interfaces and associated applications/services, among other examples.

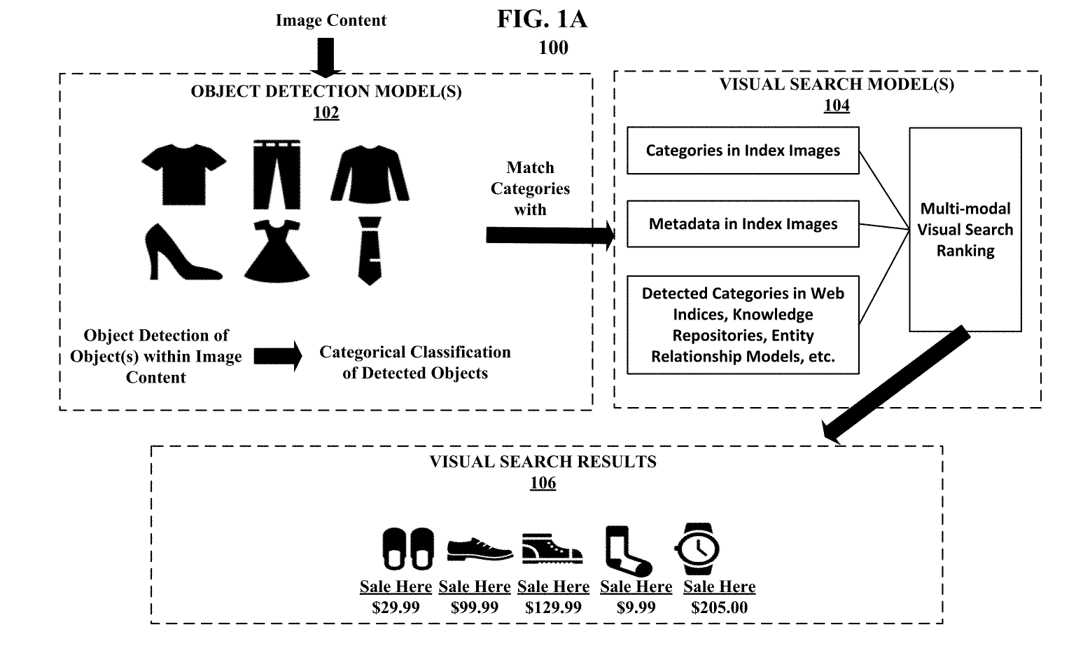

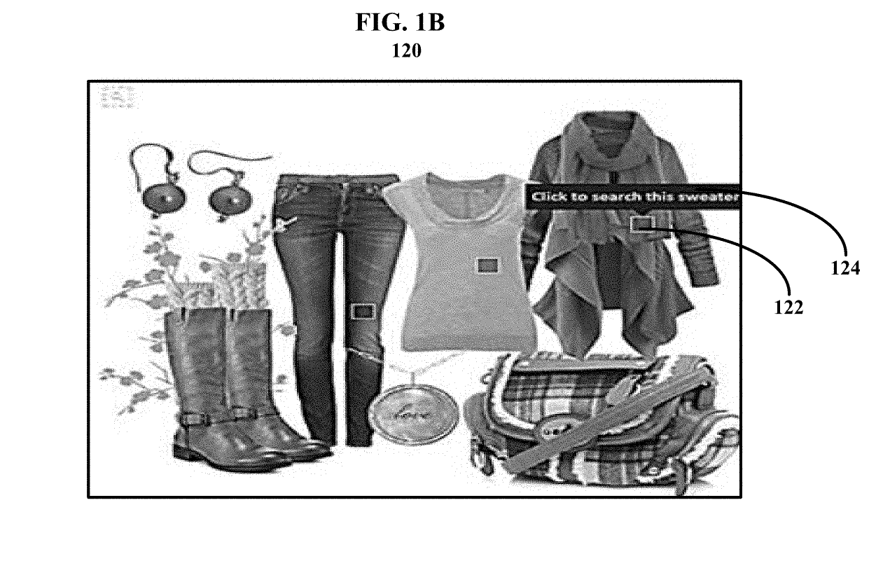

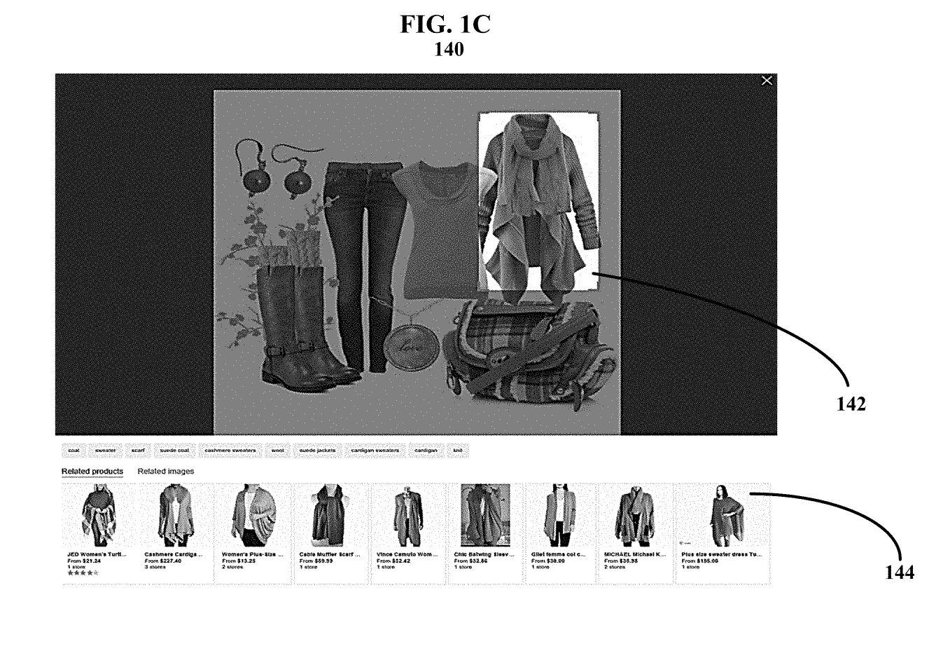

FIGS. 1A-1C illustrate exemplary processing examples related to object detection and generation of categorical classification for a detected object, with which aspects of the present disclosure may be practiced. FIG. 1A illustrates process flow 100, which diagrams processing by an exemplary object model, visual search processing (including implementation of an adapted visual search model) and generation of contextually relevant visual search results for detected objects. FIGS. 1B and 1C illustrate processing device views 120 and 140, respectively, which provide front-end user interface examples of processing described herein.

In process flow 100 (FIG. 1A), image content is accessed by an exemplary object detection model 102. In one example, image content and associated context data may be accessed in real-time (or near real-time), for example, where a user is accessing image content through an application/service. For instance, a user may be actively accessing the image content through a camera application/service of a mobile computing device, uploading the image content for an image search through a search engine service, etc. In another non-limiting example, a user may have uploaded image content for searching through a search engine application/service. In other instances, access to image recognition processing may not rely on an active usage of the image content by a user. An exemplary object detection model 102 may be configured to parse image content of an application/service (e.g., on a computing device, distribute network resource) and proactively initiate object detection processing to improve efficiency and operation of applications/services at run-time, among other technical advantages.

Image content may comprise one or more image files, for example, that are stored in a memory of a computing device and/or a distributed network storage (and accessed via a client computing device). Context data (or context for the image content) may comprise signal data that accompanies the image content. Context data may be in the form of metadata that is directly associated with the image content (properties, tagging, fields, storage location (e.g., folders, labels)), capture of the image content (e.g., timestamp data, geo-locational data, computing device used to capture image, application/service used to capture), modification of the image content, sharing of the image content (e.g., via social networking services) and user signal data (e.g., user profile data), among other examples. Capture of image content and associated signal data is known to one skilled in the field of art. Image content and associated context may be detected by or propagated to an exemplary object detection model 102.

An object detection model 102 is a trained data model (or models) implementing a state-of-the-art framework for object detection that is configured to execute processing operations related to detection and classification of objects within image content. State-of-the-art object detection networks depend on regional proposed algorithms to hypothesize object locations, object bounds and the nature of objects at positions within image content. An exemplary object detection model is an underlying detection model for visual search processing that enhances processing efficiency of visual search processing by utilizing categorical object classifications to identify contextually relevant content for a detected object. Objects may relate to any visible content including: physical objects, nouns/pronouns such as people, animals, places, things, languages, etc. As an example, the object detection data model 102 may be a trained neural network model (e.g., artificial neural network (ANN), convolutional neural network (CNN), Deep Neural Network (DNN)) or other types of adaptive or deep machine-learning processing. Methods and processing for building, training and adapting deep learning models including building of feature maps are known to one skilled in the art.

An exemplary object detection model 102 is implemented to detect bounds of objects within images as well as categorically classify detected objects within the image content. Classification of objects may be achieved through generation and application of one or more feature maps that intelligently apply training data to evaluate image content, detect objects within the image content and generate categorical classifications for the detected objects. An exemplary feature map is a function that maps data vectors to feature span in machine learning modeling. In examples described herein, feature maps are generated to train exemplary classifiers and enhance data modeling processing for object detection and classification (e.g., per-region analysis of image content). Exemplary data modeling may be trained to generate feature maps specific to: feature extraction, object detection and object classification, among other examples, where feature maps may be shared between neural network layers (e.g., convolutional layers) to tailor data model processing for object detection-specific evaluation of image content. In examples described herein, propagation of features maps of the object detection model 102 to a visual search processing model may assist with adaption of a visual search model for object detection evaluation including classifier training.

In addition to object detection processing, an exemplary object detection model 102 is configured to generate exemplary categorical classifications for specific objects within image content. Exemplary categorical classifications may comprise hierarchical classifications of a detected object that can be used to retrieve, curate and surface content that is most contextually relevant to a detected object. Detected objects may be classified at one or more levels of hierarchical classification, for example, depending how much data is available to classify objects to specific levels during object detecting modeling. As an example, object detection modeling may identify a number of clothing items in image content, specifically focusing on image content associated with a dress. In that example, categorical classifications may comprise identification on various levels, including a general-level that the detected object is clothing, a specific-level that identifies that the clothing item is a dress, a more-specific level that identifies specific attributes about the dress (e.g., color, style, type, size), a more-refined level (e.g., specific brand of the dress, exact identification of dress), and so on. Exemplary categorical object classification is designed to identify and propagate as detailed of a classification as possible to enhance visual search processing. In doing, so an exemplary object detection model may classify objects based on: analysis of specific objects within image content, positioning of the objects within the image content and intent associated with the image content, among other examples. Positional data and determined intent (associated with the image content and/or specific detected objects) may further be useful to filter and rank visual search images for matching with a detected object of the image content. Further, hierarchical categorical classification of objects may further be utilized to enhance processing efficiency and productivity of applications/services at run-time. For instance, the hierarchical categorical object classifications may be surfaced to enable a user to better specify search queries, among other benefits.

In some examples, the object detection model 102 may further be configured to interface with additional components for the determination of intent associated with image content. In some examples, determination of intent may comprise evaluation of user intent associated with image content, which may be determined based on evaluation of signal data associated with image content. Intent data may be useful to assist with object detection and classification. As an example, intent may be determined from a collective evaluation of: the image content, specific objects (and positioning/regional proposal network data) within image content, relationships between objects in the image content, evaluation of signal data/metadata associated with the image content (e.g., timestamp data, geo-locational data, analysis of text/content associated with a query, annotations, user-specific data, device-specific data, among other forms of metadata). For instance, a user may have attached a comment or social media post to the image content that describes image content (and even specific objects within an image). Such data may be useful in object classification determines and may be factored into ranking/scoring for one or more of object detection and object classification. In some examples, an object detection model 102 may outsource an intent determination to components of other applications/services, which may provide probabilistic intent determinations to the object detection model 102 to enhance categorical object classification. In other examples, intent may be initially evaluated in subsequent downstream processing operations such as visual search processing. Intent determination may enhance categorical classification of objects as well as visual search processing.

Exemplary deep-learning frameworks that may be configured as the object detection model 102 may comprise but are not limited to: Faster-R-CNN and Single Shot Multi-Box Detection (SSD), among other examples. One crucial characteristic shared by most object detection algorithms is generation of category-independent region hypotheses for recognition, or “region proposals”. As compared to other frameworks where region proposals are generated offline, Faster R-CNN and similar deep-learning models speed up the process up significantly enough for object detection to be executed online. An exemplary object detection model 102 may be configured to implement multiple networks (online) to enhance object detection processing. The object detection model 102 shares full-image convolutional features between a Region Proposal Network (RPN) and an object detection network. The object detection model 102 may be configured to implement an RPN, which takes shared feature maps as input and outputs a set of rectangular region proposals. The output of this processing (e.g., rectangular region proposals) as well as the exemplary feature maps are propagated to an exemplary detection network. The detection network is trained to map region-specific features for category prediction. The detection network further detects final object positions as well as category assignments (e.g., categorical object classifications) for detected objects and propagates that data for visual search modeling 104.

An exemplary object detection model 102 may be exposed as a web service that is standalone or integrated within other applications/services such as productivity applications/services. Exposure of an exemplary object detection model 102 may comprise processing operations (e.g., calls, requests/responses) with an application/service (including an application/service that implements an exemplary visual search model 104). In one example, an application/service may interface with an exemplary object detection model 102 through an application programming interface (API). Moreover, exposure of the object detection model 102 comprises providing an up-to-date object detection model. The object detection model 102 may be continuously trained and updated to provide application/services with the highest precision and highest recall for object detection and classification in a scalable form. For instance, an exemplary object detection model 102 may be a component that is accessed (e.g., through one or more APIs) by an application/service, that ultimately surfaces a representation of a detected object. A representation of a detected object may comprise one or more of: visual identification/tagging of a detected object (e.g., categorical classification(s) for a detected object), presentation of contextually relevant visual search results or suggestions for a detected object and/or surfacing of an exemplary bounding box for a detected object, among other examples.

As referenced above, an exemplary application/service may be a productivity service. An exemplary productivity application/service is an application/service configured for execution to enable users to complete tasks on a computing device (e.g., task execution through artificial intelligence (AI)). Examples of productivity services comprise but are not limited to: word processing applications/services, spreadsheet applications/services, notes/notetaking applications/services, authoring applications/services, digital presentation applications/services, search engine applications/services, email applications/services, messaging applications/services, web browsing applications/services, collaborative team applications/services, directory applications/services, mapping services, calendaring services, electronic payment services, digital storage applications/services and social networking applications/services, among other examples. In some examples, an exemplary productivity application/service may be a component of a suite of productivity applications/services that may be configured to interface with other applications/services associated with a platform. For example, a word processing service may be included in a bundled service (e.g., Microsoft® Office365® or the like). Further, an exemplary productivity service may be configured to interface with other internet sources/services including third-party application/services, for example, to enhance functionality of the productivity service.

Categorical object classification generated by an exemplary object detection model 102 enhances searching and annotation during visual search processing including retrieval and filtering of relevant result image content and further ranking of result image content. Processing efficiency during visual search processing is greatly improved, for example, through running online object detection models on billions of images in an image index (or indices), and storing the extracted features and categorical classification for detected objects. Among other technical advantages, visual search processing may recognize a reduction in latency during processing as well as improved accuracy and relevance during visual search analysis. This will lead to better object level matching for the query and index, and thus helps to achieve more accurate visual search ranking.

An exemplary object detection model 102 is configured to determine an exemplary bounding box for a detect object (or objects) within image content. An exemplary bounding box corresponds to a set of rectangular region proposals generated through RPN data processing. Examples described herein are not limited to rectangular-shaped region proposals, as it is intended to be understood that an RPN network may be programmed to generate other types of shapes for region proposals of detected objects. More specifically, the object detection model 102 is applied to both the image content (e.g., query image) and index images (associated with one or more indices of the object detection model 102) to extract both the object categories (i.e. categorical object classifications) and feature vectors that represents the object in the detected bounding box. The feature vectors from both ends are propagated to the visual search model 104, for example, to enhance filtering learning and ranking learning executed during visual search processing. In addition to improving processing efficiency during visual search processing, propagation of such exemplary data also enables identification and surfacing of richer representations of the images.

Results from processing by the object detection model 102 as well as the image content may be propagated to the visual search model 104. The visual search model 104 may comprise one or more components that are configured to execute visual search and annotation processing. General visual search and annotation processing is known to one skilled in the field of art. The visual search model 104 may comprise access to one or more visual indexes (e.g., databases) that are utilized to match image content (or portions thereof) to existing image content. Visual search analysis methodologies may comprise one or more of: nearest neighbor visual search analysis, image classification (e.g., categorical image classification) analysis and/or instance retrieval analysis, among other examples. Processing for such visual search analysis methodologies are known to one skilled in the field of art. Visual search processing may further comprise annotating accessed image content based on execution of one or more visual search analysis methodologies. Other examples of databases, indices and knowledge repositories that may be accessed for visual search and entity annotation comprise but are limited to: entity answer databases/knowledge graphs, question and answer applications/services, image insight analysis applications/services, video detail analysis applications/services, bar code recognition applications/services, optical recognition applications/services and social networking applications/services, among other examples.

For common visual search systems, the source of a visual search index comprises a growing number of internet images. However, in previous implementations of visual search systems, there may be a large number of object level visual search queries, but most of the index images are not classified at the object level. This is because, as discussed previously, most visual search indices are geared toward image classification rather than object classification. This may limit accuracy and relevance when dealing with specific objects and relevance. Processing described herein is configured to adapt visual search processing for evaluation of index images at the object level, where an exemplary visual search model 104 is adapted for filtering and ranking of contextually-related content based on exemplary categorical object classifications and other associated data (e.g., feature maps, intent, bounding box identification, contextual signal data and analysis) propagated by an exemplary object detection model 104.

To further grow an exemplary visual search index (or indices) with object level images, object detection processing results are applied on newly crawled interest image content to extract high quality object snapshots (i.e., object-specific snippets). When content, identified at an object level, is collected, exemplary visual search processing may further be enhanced by combining such content (object-specific snippets) with associated web page meta data. The object snippet and associated metadata may be stored as a new source of index growth for visual search indices. These newly generated object images are used to enhance precision and relevance when the search query is also an object, especially in instances where portions of image content (e.g. regions of image content that may be associated with detected objects) are being matched with cropped visually similar image content. Object-specific indices may be specifically searched during at the time of visual search processing, used to train/curate image content in other visual search indices and/or used to rank visually similar images.

As identified above, data propagated by the object detection model is used to enhance content retrieval and filtering of image content through visual search processing. Categorical object classifications, provided by neural network image classifiers (e.g., implemented by the object detection model 102) are important features, and are stored in indices for not only content retrieval but also ranking of retrieved content. Object detection provides not only more accurate localization of an exemplary bounding box for a detected object but also provides more precise object category description that can improve searching and filtering of image content during visual search processing.

Categorical classification of detected objects, propagated from the object detection model 102, may be matched with categorical data that is identified during visual search processing. This may enhance content retrieval to capture more contextually relevant image content, during searching, for a detected object. As referenced above, the visual search model 104 is configured to match categorical classification of detected objects with categorical data associated with index images identified through search of a visual search index or indices. Moreover, the categorical object classification (e.g., object categories) given by the object detection model may also be used to match text from the web page metadata. In an exemplary visual search system, an image index stores not only the feature vectors extracted from and representing the images, but also the metadata such as surrounding texts, product information, and related description from the webpage containing the image. In one example, such data is stored in a representative data unit of an index, where the data unit may be referred to as a “nodule.” Processing operations described herein may be configured to apply Natural Language Processing (NLP) technologies to extract representative and compact text information, or entities, from the web page metadata, nodules, etc. This may further enhance content retrieval and ranking of retrieved content. Moreover, categorical object classifications may further be matched with detected categories in other indices, accessed across the web, including but not limited to: search engine indices, knowledge repositories, entity relationship models/databases, or the like. This may further extend the pool of contextually relevant image content to associate with a detected object.

As referenced above, the visual search model 104 may further execute filtering processing operations to filter content retrieved from visual search processing. For example, retrieved image content that is visually similar and contextually relevant to the initial image content may be filtered. Filtering processing operations, executed by the visual search model 104, may comprise but are not limited to: sanitization processing (e.g., removal of unwanted or explicit image content), de-duplication processing (e.g., removal of duplicative image content) and ranking processing. General processing for such filtering operations are known to one skilled in the field of art.

With respect to ranking, the visual search model 104 is configured to implement multi-modal visual search ranking. In doing so, an exemplary visual search model 104 is configured to evaluate the image content for relevance from multiple perspectives (e.g., categorical classification matching of index images, categorical classification of metadata associated with index images, categorical classification retrieved from other indices, knowledge repositories). Such features are extracted via processing by an exemplary object detection model 102 and used to adapt the visual search model 104 for object detection classification processing. As identified above, categorical object classification may comprise hierarchical levels of object analysis, which may be further utilized to improve ranking processing. Compared with existing solutions for visual search ranker training, features extracted by an exemplary object detection model 102 (or models) contain more accurate shape and location information of the object, as well as rich contextual information.

Moreover, an exemplary object detection model 102 may be configured to propagate detected information including layers of output feature maps for multi-modal ranking training of a ranker utilized for visual search processing. In one example, the object detection model 102 may be applied to both a query image as well as indexed images to extract both object categories and feature vectors that represents the object in the detected bounding box. Feature vectors from query-side image content as well as indexed image content may be fed into ranker learning to tailor a visual search ranker for object classification evaluation. This may enable visual search processing to identify and output visual search results 106 that are more contextually relevant to a detected object as well as provide richer representations of image content (as compared with general image classification processing), among other technical advantages.

Processing for ranker learning and application are known to one skilled in the field of art. In present examples, since metadata is stored at different (object classification) levels of hierarchy, object detection category matching can be applied to different levels of classification during ranking processing. For example, categorical object classification may be applied as Best Represented Queries (BRQ) to match page text and metadata. Alternatively, categorical object CLASSIFICATION may be used as a filter set and L1/L2 ranking may be applied to further filter out semantically irrelevant documents and enhancing ranking results relevance. Further, candidate for visual search results 106 may be ranked not only based on relevance to a detected object but also relevance to the image content as a whole. Preliminary empirical research indicates exemplary ranking processing shows greater gains in accuracy and relevance (e.g., as measured by Discounted Cumulative Gain (DCG) or the like).

The visual search model 104 is configured to output a ranked listing of visual search (image) results 106. Exemplary visual search results 106 comprise one or more visually similar images for a detected object, where visually similar images may be surfaced as visual search results based on ranking processing executed by the visual search model 104. Any number of results may be selected for output from the visual search results 106, for example, based on application/service processing, available display space, etc. Image content in visual search results 106 is contextually relevant for one or more detected objects within exemplary image content. Visual search results 106 may vary depending on detected objects within image content as well as determined intent associated with the image content (e.g., from a query, user-signal data, device signal data). For instance, if the user is looking for outfit inspiration in a search engine, processing described may be utilized to predict the search/shopping intent of users, automatically detect several objects of user interests and marks them so users don't have to manipulate a bounding box associated with the object as in existing techniques, execute further queries, etc.

Furthermore, in some instances, the visual search model 104 may be further configured to generate a representation of a detected object (or objects). In other examples, the visual search model 104 is configured to propagate visual search results 106 and other associated data to an exemplary application/service (e.g., productivity service) for generation of a representation of one or more detected objects through a user interface of the application/service. A representation of a detected object may comprise one or more of: visual identification/tagging of a detected object (e.g., categorical classification(s) for a detected object), presentation of contextually relevant visual search results or suggestions for a detected object and/or surfacing of an exemplary bounding box for a detected object, among other examples. Non-limiting examples related to surfacing of an exemplary representation of a detected object are illustrated in FIGS. 1B-1C.

FIG. 1B illustrates processing device view 120. Processing device view 120 illustrates a front-end user interface example related to surfacing of representation(s) of a detected object through a user interface of an exemplary application/service. Processing device view 120 illustrates an example where a user is executing a search query (using image content) to seek outfit (clothing) inspiration. Results from back-end object detect processing and visual search processing, as detailed in the foregoing description, are initially illustrated through the representation(s) of the object shown in processing device view 120. For example, an exemplary hot spot 122 user interface feature may be associated with a detected object within the image content. An exemplary hot spot 122 is surfaced in a representation of the detected object as an initial indication of results of object detection processing. In the example shown, hot spot 122 is a user interface feature that corresponds to object detection processing, where processing has identified that the object (in the upper right corner of the image content) is a sweater. The hot spot 122 provides a selectable indication based on results of the object detection processing.

Additionally, an exemplary representation of the object (e.g., sweater) may further comprise a user interface representation 124 of the categorical object classification for the detected object. As an example, an application/service may be configured to not only show users exemplary hotspots or bounding boxes for detected image content but also the detected category of the object. As identified in the foregoing description, an exemplary categorical object classification may comprise N number of hierarchical levels for a detected object. An exemplary user interface representation 124 of the categorical object classification may correlate with one or more of the hierarchical levels of classification for the detected object. In the instance shown in processing device view 120, an exemplary user interface representation 124 provide context for a categorical classification of the detected object (e.g., sweater), where text reciting “click to search this sweater” is presented for the user. This user interface representation 124 provides not only identification of the detected object but also a suggestion for the user to click-through and continue shopping (e.g., based on the detected intent). In such a way, an exemplary user interface representation 124 is contextually relevant to the user.

FIG. 1C illustrates processing device view 140, which provides another front-end user interface example related to surfacing of representation(s) of a detected object through a user interface of an exemplary application/service. Processing device view 140 illustrates a representation of a detected object (e.g., sweater) that comprises an exemplary bounding box user interface feature 142. In some instances, an exemplary bounding box user interface feature 142 may be automatically surfaced based on object detection processing. In other instances, the bounding box user interface feature 142 may be surfaced based on selection of an exemplary object within the image content or a representation of a detected object. In one example, if users click on an exemplary hotspot (e.g., hotspot user interface feature 122) over an object of interest, the search engine may automatically position the bounding box user interface feature 142 in the right place for that detected object. In further instances, such action may trigger a search, showing exemplary visual search results 144 for the detected object. In some examples, exemplary visual search results 144 may be automatically surfaced based on object detection processing. For instance, contextually relevant visual search results may be presented along with the image content, query search results, suggestions, etc. (e.g., in the same pane/window or a separate pane/window). In other examples, the visual search results 144 may be surfaced based on selection of an exemplary object within the image content or a representation of a detected object.

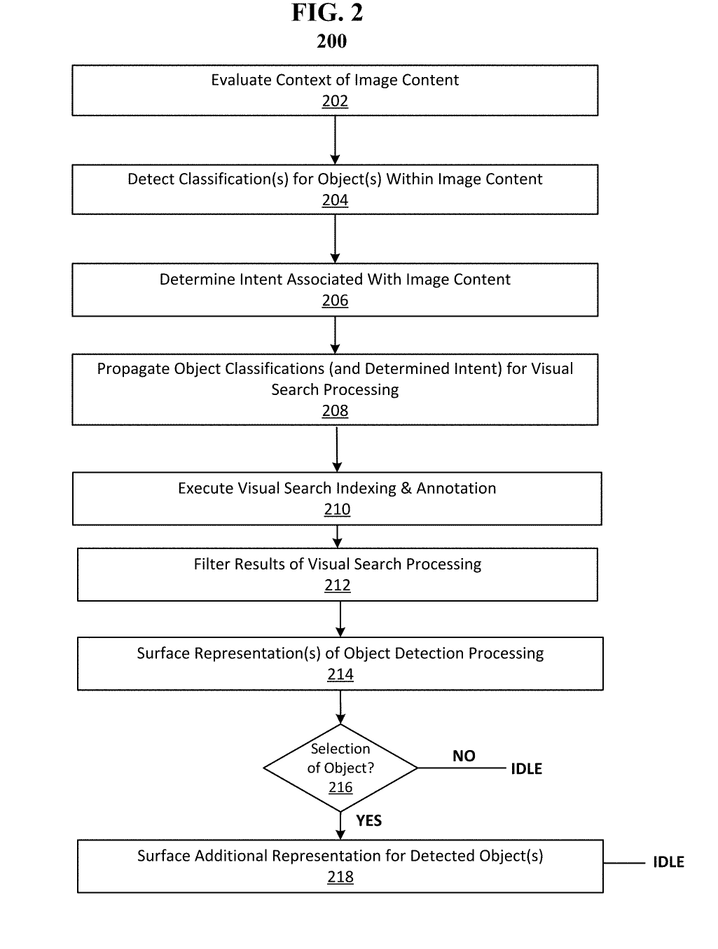

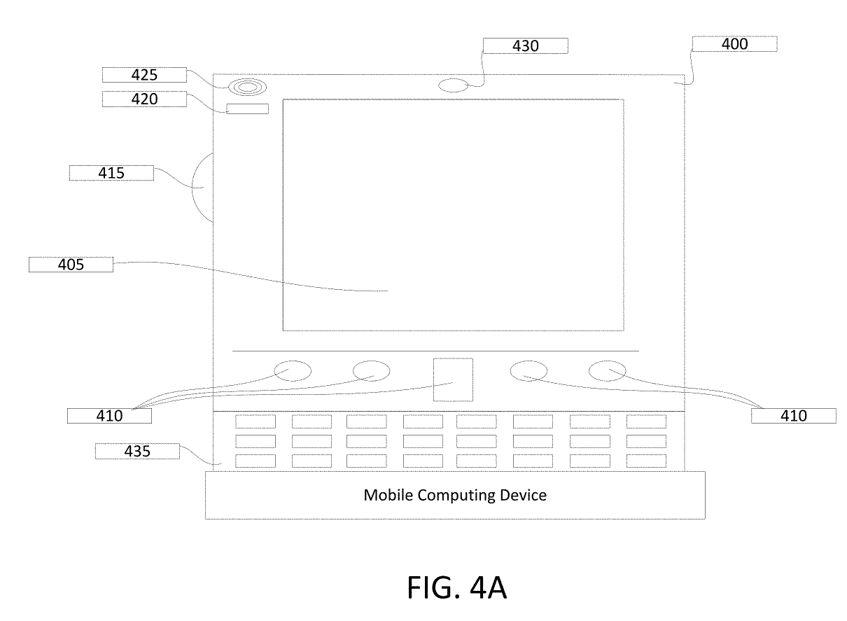

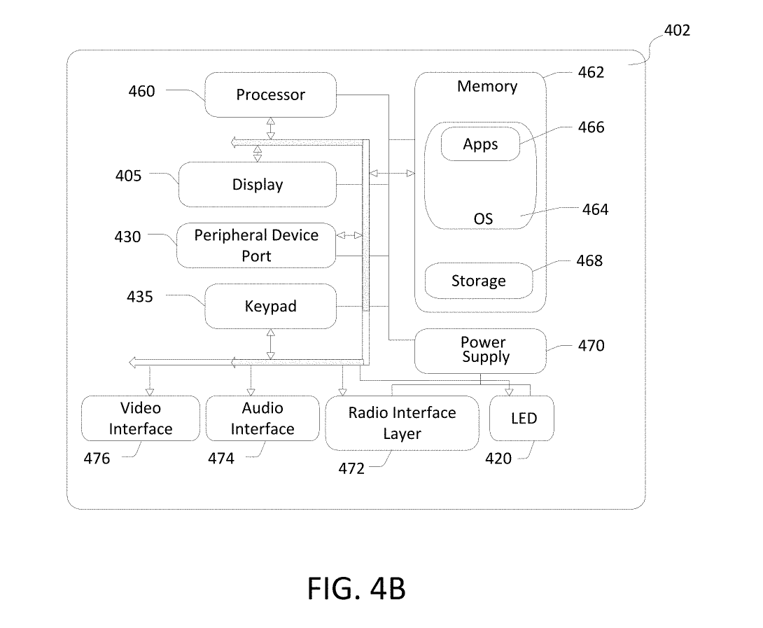

FIG. 2 illustrates an exemplary method 200 related to specific processing operations executed by an exemplary contextual image analysis service with which aspects of the present disclosure may be practiced. As an example, method 200 may be executed by an exemplary computing device (or computing devices) and/or system such as those shown in FIGS. 4A-6. For instance, processing operations described herein may be executed by one or more components of any of: an exemplary object model, an exemplary visual search model, system that executes collaborative processing of described models and/or an exemplary application/service (as described in process flow 100, FIG. 1A). Further, any of the previously described components may be configured to interface with a computing device (or devices) and/or applications/services executing thereon to achieve processing as described herein.

Operations performed in method 200 may correspond to operations executed by a system and/or service that executes computer programs, APIs, neural networks or machine-learning processing and semantic and entity understanding modeling, among other examples. As an example, processing operations executed in method 200 may be performed by one or more hardware components. In another example, processing operations executed in method 200 may be performed by one or more software components. In some examples, processing operations described in method 200 may be executed by one or more applications/services associated with a web service that has access to a plurality of application/services, devices, knowledge resources, etc. In one instance, processing operations described in method 200 may be implemented by one or more components connected over a distributed network.

Method 200 begins at processing operation 202, where a context of exemplary image content is evaluated. Access to and evaluation of exemplary image content is described in the foregoing description including the description of process flow 100 (FIG. 1A). For example, evaluation (processing operation 202) of a context of image content may be executed through application of exemplary object detection model (e.g., object detection model 102 of FIG. 1A). Context of image content may correspond to an evaluation of the image content and associated signal data. As described previously, context data may be in the form of metadata that is directly associated with the image content (properties, tagging, fields, storage location (e.g., folders, labels)), capture of the image content (e.g., timestamp data, geo-locational data, computing device used to capture image, application/service used to capture), modification of the image content, sharing of the image content (e.g., via social networking services) and user signal data (e.g., user profile data), among other examples. Evaluation of a context of the image content may assist with determination of user intent and generation of exemplary visual search results and exemplary representations of a detected object.

Flow of method 200 may proceed to processing operation 204, where exemplary objects within the accessed image content are classified. As described in the foregoing description (e.g., process flow 100 of FIG. 1A), object detection and classification are executed by an exemplary object detection model. Exemplary categorical object classification(s) may be generated for a detected object or group of objects within image content.

In some examples, evaluation of image and context comprises determination (processing operation 206) of intent associated with the image content. Determination of intent and application of a determined intent for enhancement of visual search processing have been described in the foregoing description (e.g., refer to process flow 100 of FIG. 1A). As an example, exemplary intent is determined based on analysis of signal data associated with the image content and the one or more categorical classifications. Moreover, exemplary intent determination(s) may be propagated to enhance visual image search processing. For example, filtering of visually similar images (by a service implementing an exemplary visual search model) may occur based on categorical classifications and the determined intent.

Flow of method 200 may proceed to processing operation 208, where data associated with categorical classification of the object (as well as other relevant signal data) may be propagated for visual search processing. Examples of data propagated by an exemplary object detection model are provided in the foregoing description. An exemplary visual search model (e.g., visual search model 104 described in the description of FIG. 1A) may be configured to execute processing operations related to exemplary visual search indexing and annotation (processing operation 210). For instance, processing operation 210 may comprise identification of visually similar images (and associated annotations) for a detected object within the image content as well as annotation of image content identified from a visual search index. In examples, data propagated from an exemplary object detection model may be utilized to enhance content retrieval executed by an exemplary visual search model as described in the foregoing description.

At processing operation 212, results of visual search processing are filtered. Filtering (processing operation 212) of visually similar image content (e.g., images and associated annotations) may be executed based on the propagated data including exemplary categorical classifications. As an example, processing operation 212 may comprise comparing categorical object classification data with data associated with visual search indices (e.g., categories of visual search indices, detected categories in index images), metadata in visual search indices and/or categorical classifications, keywords, etc., and/or associated with other web indices, knowledge graphs, and entity relationship models, among other examples. Contextual relevance of visually similar image content may be identified based on such a comparison.

Filtering (processing operation 212) of visually similar images for the objects(s) of image content may comprise ranking results data for contextually relevance to a detected object. An exemplary ranker for visual search processing may be trained for object classification ranking. As an example, exemplary categorical object classifications (provided by an exemplary object detection model) may be utilized for training or adaptation of a visual search ranker. For instance, content retrieved through visual search processing and annotation may be ranked based on contextual relevance to a detected object (or objects) based on the data propagated from processing by an exemplary object detection model. As an example, data propagated by the object detection model may comprise one or more categorical classifications for a detected object and feature maps for object detection and/or exemplary categorical classification. As described in the foregoing description, an exemplary multi-modal ranker, employed by a visual search model, may be adapted for object classification. Technical advantages stemming from implementation of a ranker that is trained and adapted for object detection have been described in the foregoing description, but include improved accuracy and relevance in identifying contextually relevant content for specific data objects within image content.

Flow of method 200 may proceed to processing operation 214. At processing operation 214, an exemplary representation of a detected object (e.g., representation of object detection processing) is surfaced. A representation of detected object may comprise an identification of a detected object. An identification of the detected object may be surfaced through a user interface of a service (e.g., a search service). In at least one example, the identification of the object may comprise visual reference to a categorical classification and/or filtered visually similar images for the detected object. In some examples, an exemplary representation of object detection processing may comprise surfacing of an exemplary hotspot user interface feature that may be associated with a specific object (or objects) in image content. An exemplary hotspot user interface feature is another exemplary identification of a detected object. In further examples, selection (through the user interface) of a detected object or data associated with an exemplary identification of the detected object may result in presentation of a bounding box that emphasizes the detected object. An exemplary bounding box is yet another example of an identification of a detected object. Surfacing of an exemplary bounding box may occur based on user action received through a computing device and user interface of an application/service but examples are not so limited. Further examples of exemplary representations for a detected object have been described in the foregoing description of FIGS. 1A-1C. Surfaced user interface examples related to exemplary representations of detected objects are further provided in association with FIGS. 1B-1C, described in the foregoing description.

Flow may proceed to decision operation 216, where it is determined whether a selection of a detected object (or associated representation of a detected object) occurs. As an example, a selection may occur of an object within the image content and/or a representation of a detected object (including an indication of identification for the detected object). An exemplary selection may be received through a user interface of an application/service or through other input modalities receivable through a computing device. In examples where no selection occurs, processing of decision operation 216 branches NO and processing of method 200 remains idle until subsequent processing is received.

In examples where a selection of a detected object (or representation of the detected object) occurs, flow of decision operation 216 branches YES. In that instance, flow of method 200 proceeds to processing operation 218, where additional representation(s) for detected object(s) are surfaced. Among other examples, a representation of a detected object may comprise an exemplary hotspot user interface indication or representation of an exemplary categorical classification of a detected object, as described in the foregoing. In such an instance, processing operation 218 may comprise surfacing of an additional representation for the detected object that corresponds with the received selection. For instance, selection of a detected object or exemplary hotspot user interface feature may yield presentation of an exemplary bounding box for the detected object. Selection of the detected object, categorical classification (or associated content) may yield presentation of exemplary visual search results for the detected object.

In other instances, an exemplary application/service may be configured to enable a user to access hierarchical classification data associated with exemplary object classification. As described in the foregoing description, categorical classification processing (by an exemplary object detection model) may classify a detected object to a plurality of different levels. Such data may be useful to tailoring a user interface experience and productivity of applications/services, for example, during real-time operation. In some instances, examples of hierarchical object classification (of a detected object) may be surfaced through a user interface to: enable users to tailor a search experience related to a detected object (e.g., a user may prefer to search for other categories of clothing or accessories rather than a specific object) and receive crowd-sourcing feedback regarding accuracy in classifications, among other examples.

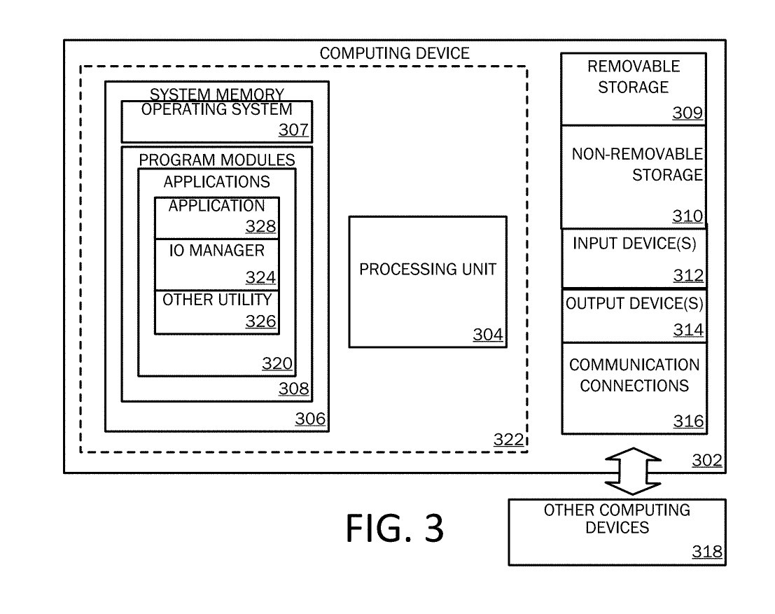

FIGS. 3-5 and the associated descriptions provide a discussion of a variety of operating environments in which examples of the invention may be practiced. However, the devices and systems illustrated and discussed with respect to FIGS. 3-5 are for purposes of example and illustration and are not limiting of a vast number of computing device configurations that may be utilized for practicing examples of the invention, described herein.

FIG. 3 is a block diagram illustrating physical components of a computing device 302, for example a mobile processing device, with which examples of the present disclosure may be practiced. Among other examples, computing device 302 may be an exemplary computing device configured for classification of objects within image content, where operations are executed to improve processing efficiency of computing devices and associated applications/services as described herein. In a basic configuration, the computing device 302 may include at least one processing unit 304 and a system memory 306. Depending on the configuration and type of computing device, the system memory 306 may comprise, but is not limited to, volatile storage (e.g., random access memory), non-volatile storage (e.g., read-only memory), flash memory, or any combination of such memories. The system memory 306 may include an operating system 307 and one or more program modules 308 suitable for running software programs/modules 320 such as IO manager 324, other utility 326 and application 328. As examples, system memory 306 may store instructions for execution. Other examples of system memory 306 may store data associated with applications. The operating system 307, for example, may be suitable for controlling the operation of the computing device 302. Furthermore, examples of the invention may be practiced in conjunction with a graphics library, other operating systems, or any other application program and is not limited to any particular application or system. This basic configuration is illustrated in FIG. 3 by those components within a dashed line 322. The computing device 302 may have additional features or functionality. For example, the computing device 302 may also include additional data storage devices (removable and/or non-removable) such as, for example, magnetic disks, optical disks, or tape. Such additional storage is illustrated in FIG. 3 by a removable storage device 309 and a non-removable storage device 310.

As stated above, a number of program modules and data files may be stored in the system memory 306. While executing on the processing unit 304, program modules 308 (e.g., Input/Output (I/O) manager 324, other utility 326 and application 328) may perform processes including, but not limited to, one or more of the stages of the operations described throughout this disclosure. Other program modules that may be used in accordance with examples of the present invention may include electronic mail and contacts applications, word processing applications, spreadsheet applications, database applications, slide presentation applications, drawing or computer-aided application programs, photo editing applications, authoring applications, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 3 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing device 402 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

The computing device 302 may also have one or more input device(s) 312 such as a keyboard, a mouse, a pen, a sound input device, a device for voice input/recognition, a touch input device, etc. The output device(s) 314 such as a display, speakers, a printer, etc. may also be included. The aforementioned devices are examples and others may be used. The computing device 302 may include one or more communication connections 316 allowing communications with other computing devices 318. Examples of suitable communication connections 316 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 306, the removable storage device 309, and the non-removable storage device 310 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 302. Any such computer storage media may be part of the computing device 302. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

FIGS. 4A and 4B illustrate a mobile computing device 400, for example, a mobile telephone, a smart phone, a personal data assistant, a tablet personal computer, a phablet, a slate, a laptop computer, and the like, with which examples of the invention may be practiced. Mobile computing device 400 may be an exemplary computing device configured for classification of objects within image content, where operations are executed to improve processing efficiency of computing devices and associated applications/services as described herein. Application command control may be provided for applications executing on a computing device such as mobile computing device 400. Application command control relates to presentation and control of commands for use with an application through a user interface (UI) or graphical user interface (GUI). In one example, application command controls may be programmed specifically to work with a single application. In other examples, application command controls may be programmed to work across more than one application. With reference to FIG. 4A, one example of a mobile computing device 400 for implementing the examples is illustrated. In a basic configuration, the mobile computing device 400 is a handheld computer having both input elements and output elements. The mobile computing device 400 typically includes a display 405 and one or more input buttons 410 that allow the user to enter information into the mobile computing device 400. The display 405 of the mobile computing device 400 may also function as an input device (e.g., touch screen display). If included, an optional side input element 415 allows further user input. The side input element 415 may be a rotary switch, a button, or any other type of manual input element. In alternative examples, mobile computing device 400 may incorporate more or less input elements. For example, the display 405 may not be a touch screen in some examples. In yet another alternative example, the mobile computing device 400 is a portable phone system, such as a cellular phone. The mobile computing device 400 may also include an optional keypad 435. Optional keypad 435 may be a physical keypad or a “soft” keypad generated on the touch screen display or any other soft input panel (SIP). In various examples, the output elements include the display 405 for showing a GUI, a visual indicator 420 (e.g., a light emitting diode), and/or an audio transducer 425 (e.g., a speaker). In some examples, the mobile computing device 400 incorporates a vibration transducer for providing the user with tactile feedback. In yet another example, the mobile computing device 400 incorporates input and/or output ports, such as an audio input (e.g., a microphone jack), an audio output (e.g., a headphone jack), and a video output (e.g., a HDMI port) for sending signals to or receiving signals from an external device.

FIG. 4B is a block diagram illustrating the architecture of one example of a mobile computing device. That is, the mobile computing device 400 can incorporate a system (i.e., an architecture) 402 to implement some examples. In one examples, the system 402 is implemented as a “smart phone” capable of running one or more applications (e.g., browser, e-mail, calendaring, contact managers, messaging clients, games, and media clients/players). In some examples, the system 402 is integrated as a computing device, such as an integrated personal digital assistant (PDA), tablet and wireless phone.

One or more application programs 466 may be loaded into the memory 462 and run on or in association with the operating system 464. Examples of the application programs include phone dialer programs, e-mail programs, personal information management (PIM) programs, word processing programs, spreadsheet programs, Internet browser programs, messaging programs, and so forth. The system 402 also includes a non-volatile storage area 468 within the memory 462. The non-volatile storage area 468 may be used to store persistent information that should not be lost if the system 402 is powered down. The application programs 466 may use and store information in the non-volatile storage area 468, such as e-mail or other messages used by an e-mail application, and the like. A synchronization application (not shown) also resides on the system 402 and is programmed to interact with a corresponding synchronization application resident on a host computer to keep the information stored in the non-volatile storage area 468 synchronized with corresponding information stored at the host computer. As should be appreciated, other applications may be loaded into the memory 462 and run on the mobile computing device (e.g. system 402) described herein.

The system 402 has a power supply 470, which may be implemented as one or more batteries. The power supply 470 might further include an external power source, such as an AC adapter or a powered docking cradle that supplements or recharges the batteries.

The system 402 may include peripheral device port 430 that performs the function of facilitating connectivity between system 402 and one or more peripheral devices. Transmissions to and from the peripheral device port 430 are conducted under control of the operating system (OS) 464. In other words, communications received by the peripheral device port 430 may be disseminated to the application programs 466 via the operating system 464, and vice versa.

The system 402 may also include a radio interface layer 472 that performs the function of transmitting and receiving radio frequency communications. The radio interface layer 472 facilitates wireless connectivity between the system 402 and the “outside world,” via a communications carrier or service provider. Transmissions to and from the radio interface layer 472 are conducted under control of the operating system 464. In other words, communications received by the radio interface layer 472 may be disseminated to the application programs 566 via the operating system 464, and vice versa.

The visual indicator 420 may be used to provide visual notifications, and/or an audio interface 474 may be used for producing audible notifications via the audio transducer 425 (as described in the description of mobile computing device 400). In the illustrated example, the visual indicator 420 is a light emitting diode (LED) and the audio transducer 425 is a speaker. These devices may be directly coupled to the power supply 470 so that when activated, they remain on for a duration dictated by the notification mechanism even though the processor 460 and other components might shut down for conserving battery power. The LED may be programmed to remain on indefinitely until the user takes action to indicate the powered-on status of the device. The audio interface 474 is used to provide audible signals to and receive audible signals from the user. For example, in addition to being coupled to the audio transducer 425 (shown in FIG. 4A), the audio interface 474 may also be coupled to a microphone to receive audible input, such as to facilitate a telephone conversation. In accordance with examples of the present invention, the microphone may also serve as an audio sensor to facilitate control of notifications, as will be described below. The system 402 may further include a video interface 476 that enables an operation of an on-board camera 430 to record still images, video stream, and the like.

A mobile computing device 400 implementing the system 402 may have additional features or functionality. For example, the mobile computing device 400 may also include additional data storage devices (removable and/or non-removable) such as, magnetic disks, optical disks, or tape. Such additional storage is illustrated in FIG. 4B by the non-volatile storage area 468.

Data/information generated or captured by the mobile computing device 400 and stored via the system 402 may be stored locally on the mobile computing device 400, as described above, or the data may be stored on any number of storage media that may be accessed by the device via the radio 472 or via a wired connection between the mobile computing device 400 and a separate computing device associated with the mobile computing device 400, for example, a server computer in a distributed computing network, such as the Internet. As should be appreciated such data/information may be accessed via the mobile computing device 400 via the radio 472 or via a distributed computing network. Similarly, such data/information may be readily transferred between computing devices for storage and use according to well-known data/information transfer and storage means, including electronic mail and collaborative data/information sharing systems.

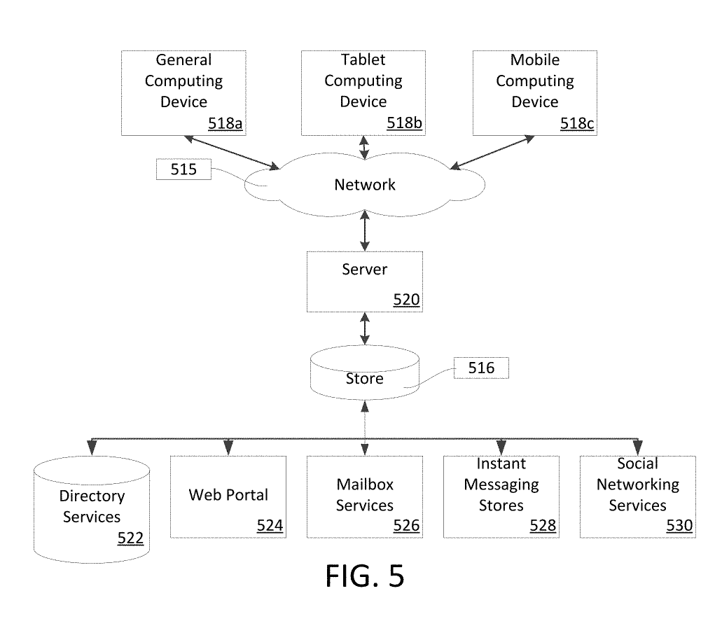

FIG. 5 illustrates one example of the architecture of a system for providing an application that reliably accesses target data on a storage system and handles communication failures to one or more client devices, as described above. The system of FIG. 5 may be an exemplary system configured for classification of objects within image content, where operations are executed to improve processing efficiency of computing devices and associated applications/services as described herein. Target data accessed, interacted with, or edited in association with programming modules 308 and/or applications 320 and storage/memory (described in FIG. 3) may be stored in different communication channels or other storage types. For example, various documents may be stored using a directory service 522, a web portal 524, a mailbox service 526, an instant messaging store 528, or a social networking site 530, IO manager 324, other utility 326, application 328 and storage systems may use any of these types of systems or the like for enabling data utilization, as described herein. A server 520 may provide storage system for use by a client operating on general computing device 302 and mobile device(s) 400 through network 515. By way of example, network 515 may comprise the Internet or any other type of local or wide area network, and a client node may be implemented for connecting to network 515. Examples of a client node comprise but are not limited to: a computing device 302 embodied in a personal computer, a tablet computing device, and/or by a mobile computing device 400 (e.g., mobile processing device). As an example, a client node may connect to the network 515 using a wireless network connection (e.g. WiFi connection, Bluetooth, etc.). However, examples described herein may also extend to connecting to network 515 via a hardwire connection. Any of these examples of the client computing device 302 or 400 may obtain content from the store 516.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While sample examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

What is claimed is:

1. A method comprising:
detecting, based on execution of an object detection data model, an object within image content;
generating, based on execution of the object detection model, one or more categorical classifications for the object within the image content;
propagating the one or more categorical classifications for visual image search processing;
filtering visually similar images for contextual relevance to the object based on the propagated one or more categorical classifications; and
presenting, through a user interface, an identification of the object that comprises the one or more categorical classifications and filtered visually similar images for the object.

2. The method of claim 1, further comprising: determining an intent associated with the object based on analysis of signal data associated with the image content and the one or more categorical classifications, propagating the determined intent for visual image search processing, and wherein the filtering filters visually similar images based on the one or more categorical classifications and the determined intent.

3. The method of claim 1, wherein the propagating further comprises propagating, to a visual search index, the one or more categorical classifications and feature maps for one or more categorical classifications, wherein the visual search index is utilized to identify the visually similar images based on the one or more categorical classifications and the feature maps for one or more categorical classifications.

4. The method of claim 3, wherein the filtering further comprises ranking visually similar image content for the object based on the propagated one or more categorical classifications and the feature maps.

5. The method of claim 1, wherein the filtering further comprises retrieving visually similar image content based on the propagated one or more categorical classifications and ranking the retrieved visually similar image content based on the propagated one or more categorical classifications.

6. The method of claim 1, further comprising: receiving a selection of one of: the object and the identification of the object, and presenting, through the user interface, a bounding box associated with object based on the received selection.

7. The method of claim 1, wherein the surfacing further comprises presenting, through the user interface, visually similar images for the object based on the filtering.

8. A system comprising:
at least one processor; and
a memory, operatively connected with the at least one processor, storing computer-executable instructions that, when executed by the at least one processor, causes the at least one processor to execute a method that comprises:
detecting, based on execution of an object detection data model, an object within image content;
generating, based on execution of the object detection model, one or more categorical classifications for the object within the image content;
propagating the one or more categorical classifications for visual image search processing;
filtering, visually similar images for contextual relevance to the object based on the propagated one or more categorical classifications; and
surfacing, through a user interface, an identification of the object that comprises the one or more categorical classifications and filtered visually similar images for the object.

9. The system of claim 8, wherein the method, executed by the at least one processor, further comprises: determining an intent associated with the object based on analysis of signal data associated with the image content and the one or more categorical classifications, propagating the determined intent for visual image search processing, and wherein the filtering filters visually similar images based on the one or more categorical classifications and the determined intent.

10. The system of claim 8, wherein the propagating further comprises propagating, to a visual search index, the one or more categorical classifications and feature maps for one or more categorical classifications, wherein the visual search index is utilized to identify the visually similar images based on the one or more categorical classifications and the feature maps for one or more categorical classifications.

11. The system of claim 10, wherein the filtering further comprises ranking visually similar image content for the object based on the propagated one or more categorical classifications and the feature maps.

12. The system of claim 8, wherein the filtering further comprises retrieving visually similar image content based on the propagated one or more categorical classifications and ranking the retrieved visually similar image content based on the propagated one or more categorical classifications.

13. The system of claim 8, wherein the method, executed by the at least one processor, further comprises: receiving a selection of one of: the object and the identification of the object, and presenting, through the user interface, a bounding box associated with object based on the received selection.

14. The system of claim 8, wherein the surfacing further comprises presenting, through the user interface, visually similar images for the object based on the filtering.

15. A computer-readable storage medium storing computer-executable instructions that, when executed by at least one processor, causes the at least one processor to execute a method comprising:
detecting, based on execution of an object detection data model, an object within image content;
generating, based on execution of the object detection model, one or more categorical classifications for the object within the image content;
propagating the one or more categorical classifications for visual image search processing;
filtering, visually similar images for contextual relevance to the object based on the propagated one or more categorical classifications; and
surfacing, through a user interface, an identification of the object that comprises the one or more categorical classifications and filtered visually similar images for the object.

16. The computer-readable storage medium of claim 15, wherein the executed method further comprising: determining an intent associated with the object based on analysis of signal data associated with the image content and the one or more categorical classifications, propagating the determined intent for visual image search processing, and wherein the filtering filters visually similar images based on the one or more categorical classifications and the determined intent.

17. The computer-readable storage medium of claim 15, wherein the propagating further comprises propagating, to a visual search index, the one or more categorical classifications and feature maps for one or more categorical classifications, wherein the visual search index is utilized to identify the visually similar images based on the one or more categorical classifications and the feature maps for one or more categorical classifications.

18. The computer-readable storage medium of claim 15, wherein the filtering further comprises retrieving visually similar image content based on the propagated one or more categorical classifications and ranking the retrieved visually similar image content based on the propagated one or more categorical classifications.

19. The computer-readable storage medium of claim 15, wherein the executed method further comprising: receiving a selection of one of: the object and the identification of the object, and presenting, through the user interface, a bounding box associated with object based on the received selection.

20. The computer-readable storage medium of claim 15, wherein the surfacing further comprises presenting, through the user interface, visually similar images for the object based on the filtering.
